(19) United States
(12) Patent Application Publication
(10) Pub. No.: US 2009/0085266 A1
(43) Pub. Date: Apr. 2, 2009

(54) INTEGRATED INSULATOR TYPE STRUT ASSEMBLY FOR SUSPENSION SYSTEM

(76) Inventor: Sangrak Kim, Seoul (KR)

Correspondence Address: MORGAN, LEWIS & BOCKIUS LLP (SF), One Market, Spear Street Tower, Suite 2800, San Francisco, CA, 94105, US

(21) Appl. No.: 11/965,524

(22) Filed: Dec. 27, 2007

(30) Foreign Application Priority Data
Oct. 2, 2007 (KR) 10-2007-0099300

(51) Int. Cl. B60G 13/00

(52) U.S. Cl. 267/195

(57) ABSTRACT

According to an embodiment of the present invention, a strut assembly of a strut suspension system, which includes a shock absorber fixed to a vehicle body panel by a fixing member, provides multiple functions to an integrated insulator that surrounds a cylinder rod of shock absorber. That is, the elastic damping mass serves as an elastic mounting bush, and serves as a spring pad and a spring seat that support a spring surrounding to shock absorber by using a damping mass. Therefore, it is possible to obtain a characteristic of strut assembly that does not include various parts such as a washer, a bush, a spring pad, and a spring seat.

### CROSS-REFERENCE TO RELATED APPLICATIONS

The present application is based on, and claims priority from Korean Application Serial Number 10-2007-0099300, filed on Oct. 2, 2007, the disclosure of which is hereby incorporated by reference herein in its entirety.

### FIELD OF THE INVENTION

The present invention relates to a suspension system, and more particularly, to a suspension where an integrated insulator is applied to a strut assembly by using merits of double wishbone type and MacPherson type suspension systems.

### BACKGROUND OF THE INVENTION

In general, a strut suspension system uses a shock absorber as a pillar for positioning a wheel, that is, a strut.

An upper portion of the strut of a strut assembly is generally fixed to a vehicle body by an insulator made of a rubber material, and a lower portion of the strut is rigidly connected to an axle housing or a steering knuckle of a wheel.

In this case, a shock absorber and a spring of the strut assembly are fixed to the vehicle body (or frame) by bolts at three points.

Strut suspension systems having the above-mentioned structure are mainly classified into a double wishbone type suspension system and a MacPherson type suspension system. For example, since a strut assembly serves as a steering shaft in the MacPherson type suspension system, a spring set for supporting an upper end of the spring is rotated, that is, the spring seat is provided with bearings so as to be rotated with respect to the vehicle body (or frame).

Further, the double wishbone type suspension system forms a path along which loads of a shock absorber and a spring are absorbed and insulated by an insulator and a bush. That is, the double wishbone type suspension system forms a path along which the load of the spring is transmitted to a vehicle body (or frame) through a spring pad and a spring seal and the toad of the shock absorber is transmitted to a vehicle body (or frame) through a seat and a bush (in general, A-B type of two upper and lower bushes) fixed to a cylinder rod.

However, each of the double wishbone type suspension system and the MacPherson type suspension system has merits and demerits. For example, when the MacPherson type suspension system uses A-B type of bushes, an insulating property against the high frequency vibration that corresponds to 15 Hz or more and is input from a shock absorber deteriorates. Further, a noise insulating performance also deteriorates due to the spring toad directly transmitted to the vehicle body (or frame).

Furthermore, when an insulator uses A-B type of bushes in the double wishbone type suspension system, the entire structure of the strut assembly becomes complicated due to a plurality of parts, thereby increasing the weight and manufacturing cost.

### SUMMARY OF THE INVENTION

Embodiments of the present invention provide a strut suspension system, which includes one insulator without bearings of a strut assembly and thus has the merits of double wishbone type and MacPherson type suspension systems.

Further, embodiments of the present invention provide a strut suspension system that has the merits of double wishbone type and MacPherson type suspension systems in order to significantly reduce the number of parts of a strut assembly, thereby simplifying the structure of a strut suspension system, to reduce the manufacturing cost and weight of the strut suspension system, to improve the layout of the strut suspension system, and to improve a strut performance.

According to an exemplary embodiment of the present invention, an integrated insulator type strut assembly for a suspension system includes a shock absorber, an integrated insulator, a mounting tower assembly, a flange nut, a fixing member, a dust cover insulator, and a spring. A cylinder of the shock absorber is fixed to a knuckle mounted on a wheel, and an end of a cylinder rod of the shock absorber is fixed to a vehicle body. A suspension arm is connected to a lower portion of the knuckle. The integrated insulator is provided below a vehicle body panel fixed to the cylinder rod of the shock absorber. The mounting tower assembly surrounds the integrated insulator so that the integrated insulator does not come in contact with the vehicle body panel. The flange nut is fastened to the cylinder rod at the upper portion of the integrated insulator. The fixing member is fixed to the cylinder rod above the flange nut with a cap insulator between the flange nut and the fixing member, and fixes the shock absorber to the vehicle body panel. The dust cover insulator is fixed to a dust cover surrounding the cylinder rod of the shock absorber, and is provided below the integrated insulator. One end of the spring is supported by a lower seat pad that is provided to the cylinder of the shock absorber, and the other end thereof is supported by the lower portion of the integrated insulator.

Further, the integrated insulator may include a recessed upper space formed at the upper portion thereof and a recessed lower space formed at the lower portion thereof so as to have a small thickness at the central portion thereof. The integrated insulator may include a damping mass that surrounds the cylinder rod of the shock absorber passing through a hole formed at the central portion of the integrated insulator. The damping mass may include an upper plate that is inserted into the upper portion of the damping mass so as to be provided along an upper side portion, and a lower plate that is inserted into the lower portion of the damping mass so as to correspond to the shape of the lower portion.

The flange nut may be disposed in the recessed upper space of the damping mass, and the dust cover insulator may be disposed in the recessed lower space of the damping mass.

According to an exemplary embodiment of the present invention, a strut suspension system, which has the merits of double wishbone type and MacPherson type suspension systems, is formed using a strut assembly of which the number of parts is significantly reduced by one insulator without bearings. Therefore, it is possible to simplify the structure of a strut suspension system, to reduce the manufacturing cost and weight of the strut suspension system, and to improve the design layout of the strut suspension system.

Further, a strut suspension system according to the exemplary embodiment of the present invention has the merits of double wishbone type and MacPherson type suspension systems. Therefore, it is possible to simplify the structure of a strut assembly, to improve an insulating property against the high frequency vibration corresponding to 15 Hz or more, and to improve an insulating property against noises that are directly transmitted to a vehicle body (or frame).

The above features and advantages of the present invention will be apparent from or are set forth in more detail in the accompanying drawings, which are incorporated in and form a part of this specification, and the following Detailed Description of the Invention, which together serve to explain by way of example the principles of the present invention.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is a view showing the structure of a strut type suspension system to which an integrated insulator type strut assembly according to an exemplary embodiment of the present invention is applied; and

FIG. 2 is a cross-section showing the structure of the integrated insulator type strut assembly according to the exemplary embodiment of the present invention.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION OF THE PREFERRED EMBODIMENTS

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

A preferred embodiment of the present invention will be described in detail below with reference to the accompanying drawings. Since the embodiment is illustrative and may be modified in various ways by those skilled in the art, the present invention is not limited to the embodiment.

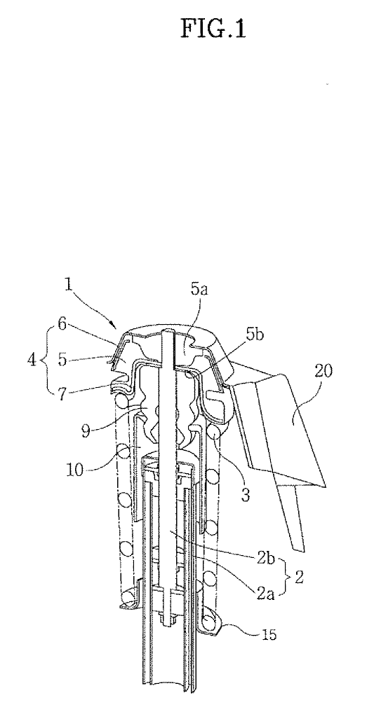

FIG. 1 is a view showing the structure of an integrated insulator type strut assembly of a strut suspension system according to an exemplary embodiment of the present invention is applied. A strut assembly 1 is fixed to a knuckle mounted on a wheel so that a suspension arm is connected to the lower portion of a strut suspension system according to an exemplary embodiment of the present invention. The strut assembly includes an integrated insulator 4. The integrated insulator 4 surrounds a cylinder rod 2b that is a fixed portion of a shock absorber 2, of which one end is fixed to the knuckle, facing a vehicle body panel.

An upper portion of integrated insulator 4 is connected to the vehicle body panel and serves as a mounting bush that is elastically deformed due to an external force, while preventing vibration from being transmitted to a vehicle body. A lower portion of the integrated insulator functions as a spring seat serving as a spring pad, and supports a spring 3 that surrounds shock absorber 2.

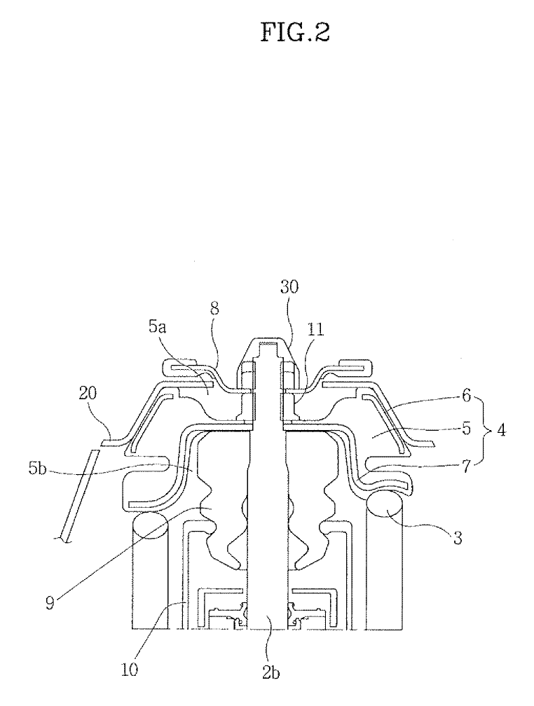

That is, as shown in FIG. 2, strut assembly 1 includes a shock absorber 2, an integrated insulator 4, a mounting tower assembly 20, and a spring 3. A cylinder 2a of the shock absorber is fixed to a knuckle of a wheel, and a cylinder rod 2b thereof is fixed to a vehicle body by a fixing member 30. The integrated insulator is provided at the lower portion of a vehicle body panel, and surrounds cylinder rod 2b of shock absorber 2. The mounting tower assembly 20 surrounds the integrated insulator 4 so that integrated insulator 4 does not come in contact with the vehicle body panel. One end of spring 3 is supported by a lower seat pad 15 of cylinder 2a of shock absorber 2, and the other end thereof is supported by the lower portion of integrated insulator 4,

In addition, strut assembly 1 further includes a dust cover insulator 9 that is provided below the integrated insulator 4 and surrounds a portion of cylinder rod 2b of shock, absorber 2, lower portion of the dust cover insulator 9 is fixed to dust cover 10 that surrounds cylinder 2a of shock absorber 2.

The integrated insulator 4 includes a recessed upper space 5a formed at the upper portion thereof and a recessed lower space 5b formed at the lower portion thereof so as to have a small thickness at the central portion thereof. Further, the integrated insulator 4 includes a damping mass 5 that surrounds upper portion of cylinder rod 2b of shock absorber 2 passing through a hole formed at the central portion of the integrated insulator. Furthermore, damping mass 5 has a groove substantially at a circumferential portion thereof so that upper and lower portions of the damping mass 5 are distinguished from each other.

In this ease, the groove of damping mass 5 is formed near the central portion through which cylinder rod 2b of shock absorber 2 passes.

In addition, damping mass 5 includes steel plates that are inserted into a rubber material and integrally formed with the rubber material. The plates are composed of an upper plate 6 that is inserted into the upper portion of damping mass 5 so as to form an upper side portion, and a lower plate 7 that is inserted into the lower portion of damping mass 5 so as to form a lower portion.

In this case, upper plate 6 is disposed along the inclined side surface of damping mass 5, which is an upper portion of damping mass 5, and the upper plate 1 supports the mounting tower assembly 20). In contrast, lower plate 7 is disposed below damping mass 5 over the lower portion corresponding to the center hole so that cylinder rod 2b of shock absorber 2 passes through the center hole of damping mass 5.

Meanwhile, a flange nut 11 is provided on the integrated insulator 4 wherein upper portion of the cylinder rod 2b of shock absorber 2 is fixed to the vehicle body panel. As shown in FIG. 2, flange nut 11 is disposed in recessed upper space 5a of integrated insulator 4, and thread-fastened to the upper portion of cylinder rod 2b of shock absorber 2. A fixing member 30 is fixed to a distal end portion of the cylinder rod 2b above the flange nut 11 with a cap insulator 8 therebetween, so that the shock absorber 2 is fixed to the vehicle body panel.

In this case, the central portion of the cap insulator 8 is recessed as compared to the circumferential portion thereof in cross-sectional view so that cap insulator 8 is recessed toward the center hole of mounting tower assembly 20 provided above integrated insulator 4.

Further, fixing member 30 has a general structure that fixes shock absorber 2 to the vehicle body panel in the strut assembly. For example, the structure includes a nut that is thread-fastened to cylinder rod 2b of shock absorber 2, and a cover that covers them.

Furthermore, dust cover insulator 9 is provided in the recessed lower space 5b that is recessed at the lower portion of damping mass 5 of integrated insulator 4. A spring pad and a spring 3 are provided on the tower portion of damping mass 5 in which dust cover insulator 9 is not received so that the lower portion of the damping mass serves as a spring seat.

The operation of the integrated insulator type strut assembly according to the exemplary embodiment of the present invention will be described in detail below with reference to accompanying drawings.

According to the exemplary embodiment of the present invention, strut assembly 1, of the strut suspension system, which includes shock absorber 2 fixed to the vehicle body panel by fixing member 30, provides multiple functions to the integrated insulator 4 that surrounds cylinder rod 2b of shock absorber 2.

That is, the elastic damping mass 5 serves as an elastic mounting bush, and serves as a spring pad and a spring seat that support spring 3 surrounding to shock absorber 2 by using damping mass 5. Therefore, it is possible to obtain a characteristic of strut assembly 1 that does not include various parts such as a washer, a bush, a spring pad, and a spring seat.

Due to the characteristic of strut assembly 1, that is, since integrated insulator 4 is provided above shock absorber 2, of which one end is fixed to knuckle N of wheel W and the other end is fixed to the vehicle body, strut assembly 1 is configured so that the upper portion of integrated insulator 4 is fixed to the vehicle body panel by fixing member 30 and the lower portion of integrated insulator 4 supports spring 3 surrounding the shock absorber 2.

As shown in FIG. 1, damping mass 5, which forms the shape of the integrated insulator, is made of an elastic material so that integrated insulator 4 comes in contact with mounting tower assembly 20 attached to the vehicle body and absorbs load input to strut assembly 1 like a mounting bush,

In this case, damping mass 5 is formed of a single body, and has a structure of which upper and lower portions are distinguished from each other by a groove inward formed at a circumferential portion thereof. Therefore, when a load applied to the damping mass, the lower portion is easy to be elastically deformed.

Further, upper and lower plates 6 and 7 made of steel are inserted into damping mass 5 of integrated insulator 4 in order to improve the stiffness of the integrated insulator. Upper plate 6 of the plates is provided at the side portion of damping mass 5 coming in contact with mounting tower assembly 20, and lower plate 7 is provided along the lower portion of damping mass 5 where spring 3 is placed and supported. Accordingly, the lower plate elastically supports spring 3 that acts, depending on an input load.

In addition, dust cover insulator 9, which is fixed to an upper portion of dust cover 10 surrounding cylinder 2a of shock absorber 2, is provided below the damping mass 5.

As described above, the upper portion of strut assembly 1 is composed of integrated insulator 4, flange nut 11, cap insulator 8, and fixing member 30. Dust cover insulator 9 surrounding the shock absorber 2 is provided at the lower portion of strut assembly 1, and spring 3 is placed on and supported by the lower portion of integrated insulator 4.

Accordingly, as shown in FIG. 2, strut assembly 1 is fixed by fixing member 30 at the upper side of cap insulator 8, where cylinder rod 2b of shock absorber 2 is separated from the vehicle body panel, with respect to integrated insulator 4, thereby forming the upper portion of integrated insulator 4.

Dust cover insulator 9 surrounding an upper portion of cylinder rod 2b of shock absorber 2 is provided at the strut assembly and spring 3 surrounding the shock absorber 2 is placed on the strut assembly, thereby forming the lower portion of integrated insulator 4.

In this case, mounting tower assembly 20, which surrounds and covers the integrated insulator 4 so that integrated insulator 4 does not come in contact with the vehicle body panel, is provided at the upper portion of integrated insulator 4. Further, flange nut 11 is thread-fastened to a distal end portion of cylinder rod 2b of shock absorber 2 below the cap insulator 8 on which the fixing member 30 is fastened, and is positioned between the integrated insulator 4 and the cap insulator 8.

According to the structure of strut assembly 1, a force transmission path of strut assembly 1 is unified as integrated insulator 4. That is, when a load input by shock absorber 2 is transmitted to strut assembly 1, the load is transmitted to the vehicle body through flange nut 11 and cap insulator 8 that are provided at the upper portion of integrated insulator 4, while being absorbed by the dust cover insulator 9 surrounding cylinder rod 2b of shock absorber 2 and integrated insulator 4 to be elastically deformed.

In addition, when a load that is input by spring 3 surrounding the shock absorber 2 is transmitted to strut assembly 1, the toad is transmitted to the vehicle body through flange nut 11 and cap insulator 8, which are provided at the upper portion of integrated insulator 4, while being absorbed by the integrated insulator 4 that is classically deformed at the lower portion thereof. Meanwhile, spring 3 is placed on the lower portion of the integrated insulator.

In this case, lower plate 7, which is provided at the lower portion of damping mass 5 of integrated insulator 4, serves as an input path of a load that is transmitted through shock absorber 2 and spring 3.

The forgoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiment were chosen and described in order to explain certain principles of the invention and their practical application, to thereby enable others skilled in the art to make and utilize various exemplary embodiments of the present invention, as well as various alternatives and modifications thereof. It is intended that technical spirit and scope of the present invention be defined by the Claims appended hereto and their equivalents.

What is claimed is:

1. An integrated insulator type strut assembly for a suspension system, the strut assembly comprising:
a shock absorber including a cylinder rod and a cylinder partially enclosing the cylinder rod;
an integrated insulator that is provided below a vehicle body panel fixed to the cylinder rod of a shock absorber;
a mounting tower assembly covering the integrated insulator so that the integrated insulator does not come in contact with the vehicle body panel;
a flange nut that is fastened to a distal end portion of the cylinder rod at the upper portion of the integrated insulator;
a fixing member that is fixed to the cylinder rod above the flange nut with a cap insulator interposed between the flange nut and the fixing member, and fixes the shock absorber to the vehicle body panel;
a dust cover insulator that is fixed to a dust cover surrounding a portion of the cylinder rod of the shock absorber and is provided below the integrated insulator; and
an elastic member of which a proximate end portion of the elastic member is supported by a lower seat pad provided to the cylinder of the shock absorber and a distal end portion of the elastic member is supported by the lower portion of the integrated insulator.

2. The strut assembly as defined in claim 1, wherein a proximate end portion of the cylinder is fixed to a knuckle mounted on a wheel and a distal end portion of the cylinder rod is fixed to a vehicle body, the suspension arm being connected to a lower portion of the knuckle.

3. The strut assembly as defined in claim 1, wherein 1, the elastic member is a spring.

4. The strut assembly as defined in claim 1, wherein the integrated insulator includes:
a recessed upper space formed at the upper portion thereof;
a recessed lower space formed at the lower portion thereof so as to have a small thickness at the central portion thereof; and
a damping mass that surrounds a distal end portion of the cylinder rod of the shock absorber passing through a hole formed at the central portion of the integrated insulator, the damping mass including at least a plate that is inserted into the damping mass at upper and lower portions of the damping mass.

5. The strut assembly as defined in claim 4, wherein the damping mass has a groove at a circumferential portion thereof so that upper and lower portions of the damping mass are distinguished from each other.

6. The strut assembly as defined in claim 4, wherein the groove of the damping mass is formed below the central portion, where the hole through which the cylinder rod of the shock absorber passes is formed.

7. The strut assembly as defined in claim 4, wherein the plates comprises:
an upper plate that is inserted into the upper portion of the damping mass so as to be provided along an upper side portion; and
a lower plate that is inserted into the lower portion of the damping mass so as to correspond to the shape of the lower portion.

8. The strut assembly as defined in claim 7, wherein
the upper plate is disposed along the inclined side surface of the damping mass, which is an upper portion of the damping mass, and
the lower plate is disposed below the damping mass over the lower portion corresponding to a center hole so that the cylinder rod of the shock absorber passes through the center hole of the damping mass.

9. The strut assembly as defined in claim 4, wherein the flange nut is disposed in the recessed upper space of the damping mass, and
the dust cover insulator is disposed in the recessed lower space of the damping mass.
